(19) United States
(12) Patent Application Publication
(10) Pub. No.: US 2011/0270696 A1
(43) Pub. Date: Nov. 3, 2011

(54) REUSABLE PRODUCE AND BULK-ITEM SHOPPING SYSTEM AND RELATED SALES METHOD

(76) Inventors: Andrea Starn Vincent, Cotati, CA (US); William Carlos Leet, Sebastopol, CA (US)

(21) Appl. No.: 12/916,532

(22) Filed: Oct. 30, 2010

Related U.S. Application Data
(60) Provisional application No. 61/329,295, filed on Apr. 29, 2010.

(51) Int. Cl. G06Q 30/00; B65D 30/16; B65D 30/06; B65D 30/22; B65D 33/06; B65D 30/20

(52) U.S. Cl. 705/23; 383/6; 383/121.1; 383/119; 383/120; 383/117; 383/38; 383/104

(57) ABSTRACT

A reusable produce and bulk-item shopping system and related business method designed to eliminate the need for using plastic film bags in retail sales of produce and other grocery items sold by weight. Disclosed are a caddy and a plurality of relatively smaller, reusable bags that fit neatly into the caddy. The caddy and bags are preferably sized and shaped to allow close engagement between the caddy and the smaller bags when the caddy and the bags are in the open position and filled. The smaller bags are of uniform weight, and the associated business method teaches several unique methods to easily and properly account for the weight of the bag at the check stand, in order to easily effect a net weight sale of the items in the bag.

### CROSS-REFERENCE TO RELATED APPLICATIONS

This non-provisional application relates to and claims the priority filing date of Provisional Patent Application No. 61/329,295, which has a filing date of Apr. 29, 2009.

### STATEMENT REGARDING FEDERALLY SPONSORED RESEARCH OR DEVELOPMENT

(NOT APPLICABLE).

### REFERENCE TO A SEQUENCE LISTING, ETC.

(NOT APPLICABLE).

### BACKGROUND OF THE INVENTION

1. Field of the Invention

The present invention relates to a shopping container system and pertains more particularly to sales of fresh produce and bulk items such as nuts, grains and snack mixes, which are typically placed in very light-weight plastic film bags, weighed in the bag at the checkout stand, and then placed with other groceries in a larger grocery bag. The invention further relates to a business method for selling produce and other bulk items sold by weight, in reusable packages that themselves have significant weight.

2. Discussion of the Related Art

For decades, retail grocery stores have provided plastic-film bags in the produce and bulk items sections, which customers use to bag loose items. The bagged items are then typically placed in the shopping cart or basket and transported to the checkout stand, where the checker places the bag and any contents which are sold by weight onto a scale that is linked to a computer, and enters a code identifying the contents of the bag (commonly referred to as a “PLU” or Product Look Up code). The computer establishes the purchase price with reference to the weight measured by the scale and the pre-programmed price corresponding to the PLU code entered by the clerk.

The disposable plastic-film bags provide a number of advantages to the grocer and the customer. For example, plastic produce bags provide a convenient way to keep loose items together for weighing at the checkout stand. They also promote food safety by protecting fresh produce from contact with potentially unsanitary surfaces, such as the shopping cart, the conveyor belt, the scale and the checker's hands. However, disposable plastic bags also have a number of well-known disadvantages.

Plastic bag pollution is a serious global problem and a rising issue in the public consciousness. Single-use plastic bags clog landfills, litter the streets and collect into giant islands of floating waste in the ocean gyres (areas where ocean currents tend to form large spirals). The Eastern Garbage Patch, located in the North Pacific Gyre is reported to be twice the size of Texas and is estimated to contain more than 100 million tons of plastic debris.

Plastic bag manufacturing also uses energy and creates pollution, which is not considered ecologically sustainable for a single use, throw-away item. While many grocers have implemented recycling programs for film bags, these programs are not sufficient to eliminate pollution, and the recycling process itself uses energy and creates pollution.

Reusable shopping bags, and other packaging that is more durable than traditional paper or plastic bags, have become a popular and widely-embraced, eco-friendly alternative to paper and plastic shopping bags. However, there are few examples of reusable produce bags, and to date, none of those alternatives provides all of the advantages of the disclosed invention.

While there are currently no published U.S. Utility patents or patent applications that disclose reusable produce shopping bags designed to replace plastic film bags, there are several companies that make available for sale lightweight cotton muslin or mesh bags, often with draw-string closures at the top. Examples of lightweight mesh bags include those produced and marketed by 3B Bags Co. (www.3bbags.com) and examples of cloth bags include those offered for sale by Rebel Green Co. (www.rebelgreen.com).

While these alternatives are clearly preferable to single-use plastic bags from an ecological standpoint, they do little, if anything, to protect produce from damage or contamination. Both plastic film bags and the existing, reusable, alternatives are often placed by the checker with other groceries in larger bags, which subjects tender produce items to bruising, crushing and other potential damage. Moreover, because the mesh and cloth bags are easily water permeable, fresh produce within them is susceptible to we sources of contamination commonly found in grocery stores, such as meat or poultry juice on the checkout conveyor belt, or we contaminants that may be present on the child's seat area of the shopping cart, which is often used as means for transporting produce to the check stand.

In addition, the existing reusable produce bags are not designed to be a produce aisle to refrigerator solution, in that they are typically placed in larger shopping bags at the check stand. This requires the use of a separate bag, which is ecologically disadvantageous, and encourages the co-mingling of tender produce with other grocery items, such as canned goods, which could damage the produce.

Moreover, the existing reusable produce bags may present a regulatory problem for retailers, because many of them have significant weight, but no associated business method for subtracting the weight of the bag from the gross transaction, in order to effect a correct, “net weight” sale. Some of these bags have the net weight printed on the bag, but the existing method of establishing tare weights for these bags is cumbersome compared to the methods disclosed herein.

Most states and many local governments have statutes or regulations prohibiting false tear weights and or selling food items by weight without accounting for the weight of the packaging. For example, in California, Business and Professions Code Section 12021 makes it a misdemeanor for any person to knowingly take a false tare on a container, and Section 12023 makes it a misdemeanor to sell any item based on gross weight or measure. While retailers who sell produce in plastic film bags often pre-program their point of sale systems to account for the weight of the plastic film bags, selling produce in cloth or mesh bags that weigh more than plastic film bags, without taking account for even miniscule additional weight, would subject grocers to liability for failing to take an accurate tare at the checkout stand or selling produce items by gross weight. As of Oct. 7, 2009, Rebel Green advertised on their webpage: “Weight on produce scale 0.1 lbs., weight on your conscience 0 lbs.” (see: www.rebelgreen.com/producebags.html). Venerable ethics notwithstanding, any grocer in California who sells produce in a bag weighing 0.1 lbs without taring the scale is guilty of a misdemeanor. Most states have similar regulations.

To date, no published U.S. patents or patent applications disclose a method for selling produce in a reusable, customer-supplied container that weighs more than a plastic film bag, in a manor that complies with existing Weights and Measures restrictions.

A unique method is called for that provides a standard-weight, reusable container for produce and bulk item sales, and modifies the front-end computer, scale and register system to allow retail sellers to effectuate accurate, net weight sales at the check stand, with minimal effort.

### BRIEF SUMMARY OF THE INVENTION

The present invention relates to an improved method of selling and purchasing fresh produce and other items by weight, which maintains food safety, complies with weights and measures regulations and provides all of the ecological advantages of replacing a single-use, pollution-causing and energy-consuming product with a durable, reusable alternative. In addition, the present invention provides a device that organizes and separates fragile produce items from other groceries, such as canned goods, while protecting fresh food from common grocery store contaminants.

According to one aspect of the invention, a caddy device for holding produce, in an upright position includes: a first end panel, a second end panel, a divider panel, having a first and second side, a first and second side panel, and a base. The caddy is constructed of material that is sufficiently rigid to be self standing, and not collapse of its own weight when placed on a flat surface. Preferred embodiments have reinforced cloth panels to minimize deformation of the caddy when full of produce items, but it is within the scope of the invention to use a suitably heavy fabric without reinforcement. The preferred caddy also includes carrying handles, affixed to the body of the caddy, for transporting it and its contents. Many appropriate fabrics and other materials will be apparent to skilled manufacturers. The preferred embodiments will be made of durable, food-safe fabric, such as recycled, non-woven polypropylene or sustainably-produced cotton, as these materials assist in promoting the ecological advantages of the invention. However, less ecologically friendly materials, such as nylon may be used, as long as the material and construction is durable enough to provide for multiple uses.

The base of the caddy constrains the first end panel, the second end panel, the first side panel and the second side panel to each other so that the divider panel is located substantially between the first side panel and the second side panel. The preferred caddy will have a base that is collapsible, in order to permit the caddy to be folded flat for shipping and display purposes.

The invention is suitable for use with one or more smaller bags (or similar containers), examples of which, in an upright position include: a base, two opposing side panels, two opposing end panels, and an open top. The space defined between the divider and each of the side panels of the caddy is preferably sufficient to contain at least two smaller containers (hereinafter referred to as bags, but not so as to limit the scope of the invention) on each side of the divider, arranged so that the first end panel of the first smaller bag closely engages the end panel of the caddy, the first side panel of the first smaller bag closely engages the first side panel of the caddy, the second end panel of the first smaller bag closely engages the first end panel of the second smaller bag, the first side panel of the second bag closely engages the first side panel of the caddy, the second end panel of the second bag closely engages the second end panel of the caddy.

Preferred examples of the smaller bags will have end panels that are pleated in the same way typical paper shopping bags are pleated for folding. The base of the bag differs from standard paper shopping bags, in that instead of the entire base folding upwards and laying flat against the first side panel of the bag, the base should itself be pleated lengthwise down the center, so as to collapse upward, into the interior of the bag.

The business methods disclosed herein transforms the grocery stores' computer, scale, scanner and cash register system (“front end system”) to allow the checker to place the smaller bags and their contents onto the scale, and calculate a correct, net-weight, purchase price for the contents of the bag, without including the weight of the bag in the transaction price.

Existing methods of for resetting the scale of a front end system to account for the weight of packaging (“taring the scale”) include placing an empty container on the scale and pressing a “tare” button, which sets the scale to zero with the empty container on the scale. Items can then be placed within the container and the scale will only record the net weight of the items, not the container. Other methods include programming a “table of tares” into the front end system, which is accessed by data entered by the checker. This is a pre-programmed set of tare weights, such as −0.1 oz., −0.2 oz., etc., that can be accessed by a series of keystrokes at the register to re-set the scale to a pre-determined value. Another method is to manually enter the tare weight at the register with keystrokes, such as “[tare key], 0.1 oz.”

These methods are cumbersome when applied to reusable and customer-supplied food packaging, because it requires either emptying the package or entering several additional keystrokes. In the latter case, the checker also has to determine the weight of the packaging before entering the tare data, which may require her to read small print on the bag. All of this effort at the check stand slows down the transaction and demands excessive effort on grocery store employees.

A uniform system of tare weight management is needed for the sale of produce and other bulk items in reusable packaging. Disclosed are three methods applicable to the invention of this application.

Each method requires that the bags be manufactured to strictly uniform weight tolerances, such as +/− 1/100 lbs. Assuming for the purpose of the following examples, that the bag is manufactured to weigh 0.05 lbs., the following three tare-weight methods may be employed:

Designated Keystroke Method: The first method involves entering code to transform the specialized, grocery store front end computer system to recognize a keystroke or series of keystrokes (or other data entry method—hereafter, “keystroke(s)” shall refer to any method of inputting data into the front-end system at the check stand) as a command to tare the scale at −0.05 lbs. e.g.: “[more key], 6.” Once the computer is modified to recognize these keystrokes as a command to tare the scale at the appropriate weight, the checker can enter the code at the check stand, place the filled bag on the scale and continue the transaction in the usual way, by entering the product identification data and continuing or closing out the transaction.

Unique PLU Method: This second method includes first manufacturing reusable produce bags to strict uniform weight tolerances, such as 0.05 lbs.; and then entering a unique PLU for each item sold by weight. The preferred method would use new PLUs that are very similar to the old ones, such as: old PLU=12345, new PLU=612345. The next step involves programming code which transforms the front end system to recognize a unique series of keystrokes as not only a product identifier linked to a pre-coded price-per-unit-of-weight, but also as a scale tare command. The tare weight command would implement a formula to subtract the weight of the bag from the transaction, e.g.: “gross price−(weight of the bag in pounds×purchase price per pound),” or would send a command to tare the scale at −0.05 lbs. After the new PLUs are entered into the properly modified front end system, the checker can place the filled bag on the scale, enter the unique code, and the system will render a correct net weight purchase price for the items in the bag. The checker can then continue with the next item or close out the transaction

Bar Code or MRL Method: The third method involves affixing or printing a bar code or other machine readable label (hereafter “MRL” will refer to any machine readable label, including but not limited to bar codes) onto the bag. The front end system is then modified with code that identifies the MRL with the tare weight command, such as “tare scale at −0.5 lbs,” or with a formula to account for the weight, such as “gross price−(weight of the bag in pounds×purchase price per pound). Once the front end system is properly modified, the checker can simply scan the MRL on the filled bag with an appropriate MRL reader (typically incorporated into modern front end systems), place the bagged items on the scale, and enter the product identification data to render a correct net sale price.

### BRIEF DESCRIPTION OF THE DRAWINGS

The nature, goals, and advantages of the invention will become more apparent to those skilled in the art after considering the following detailed description when read in connection with the accompanying drawing, illustrating by way of examples the principles of the invention, in which like reference numerals identify like elements throughout, wherein:

FIG. 1 is an exploded view of a shopping bag caddy system, including a shopping caddy and two produce bags, according to the present invention;

FIG. 2 is a perspective view of the shopping caddy of FIG. 1 with two produce bags located within the caddy, on the back side of the center divider;

FIG. 2A is a perspective view of the reusable shopping bag filled with produce, placed on a grocery check out scale, which is linked to a computer;

FIG. 3 is perspective view of the shopping caddy and reusable produce bags of FIG. 2, with smaller produce in the produce bags located behind the center divider and larger produce in the caddy in the front side of the center divider;

FIG. 4A is a cut-away end view of the shopping bag caddy in the open position, showing reinforcement panels within the fabric of the sides and base;

FIG. 4B is a cut-away end view of the shopping bag caddy in the partially collapsed position, showing the accordion action of the base of the caddy;

FIG. 5 is a flow chart depicting the Designated Keystroke Method summarized above.

FIG. 6 is a flow chart depicting the Unique PLU Method summarized above.

FIGS. 7 and 8 are flow charts depicting the Bar Code or MRL Method summarized above.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention.

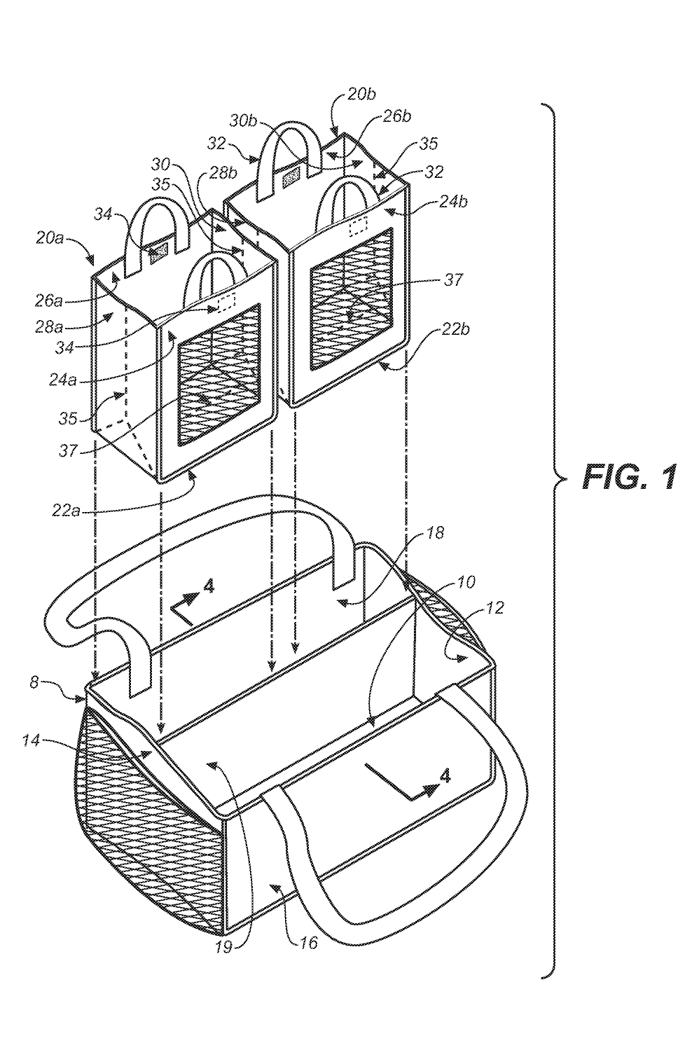

FIG. 1 shows an exploded view of a shopping bag caddy system, including a shopping caddy [8] and two smaller produce bags [20a, 20b]. Looking at the caddy, [8], the base [10] constrains the first end panel [12], the second end panel [14], the first side panel [16] and the second side panel [18] to each other so that the divider panel [19] is located substantially between the first side panel [16] and the second side panel [18].

Looking at two smaller bags of FIG. 1 [20a, 20b], each of them includes a base [22a, 22b], a first side panel [24a, 24b], a second side panel, [26a, 26b], a first end panel [28a, 28b] a second end panel [30, 30b], and an open top. These bags should be constructed ruggedly enough to withstand multiple uses, and ideally, they should be machine washable to allow easy cleaning.

Affixed to the top of the smaller bags are handles [32] for easy removal and replacement in and out of the caddy [and Velcro closures [34], which help to keep the contents of the bags [20a, 20b] contained when it is tipped over sideways. This is useful, e.g., for storing filled bags in a refrigerator drawer.

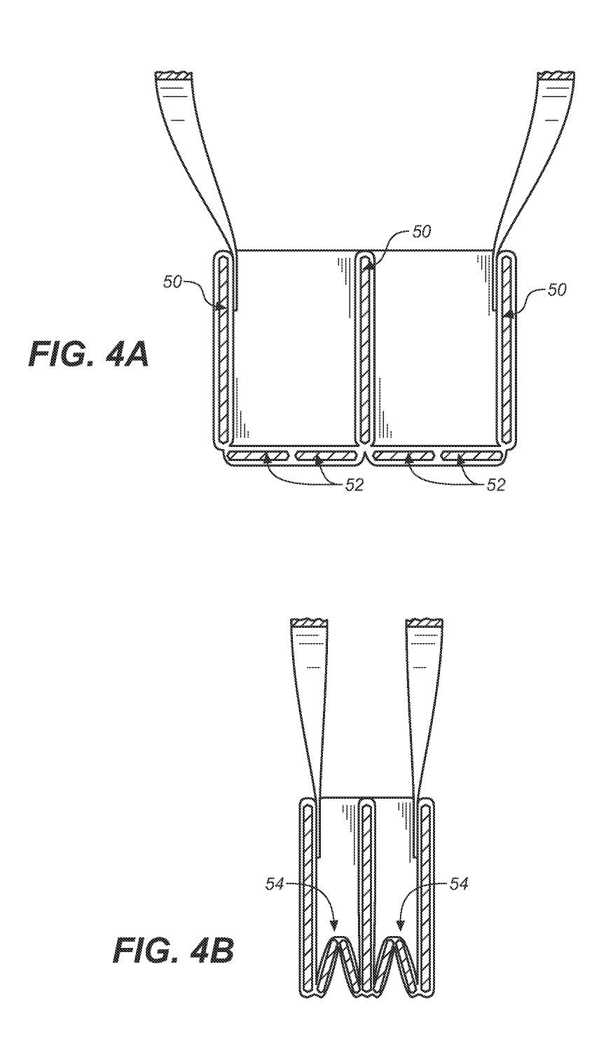

To provide for efficient folding of the smaller bag and nesting within the caddy when folded, the smaller bags should have pleats [35] which facilitate folding similar to the way standard paper shopping bags fold. However, instead of the base panel folding up against the first side panel of the bag, as paper shopping bags do, the base of the smaller bag should be pleated lengthwise down the center [37], to encourage and facilitate folding upward, into the interior of the bag, in the same way the hinged base panel of the caddy folds on each side of the divider panel, as shown in FIG. 4B, [54]. This way one or more of the smaller bags can be neatly nested into the spaces provided between the divider panel and the side panels of the caddy, and folded together relatively flat, for shipping, display and storage purposes.

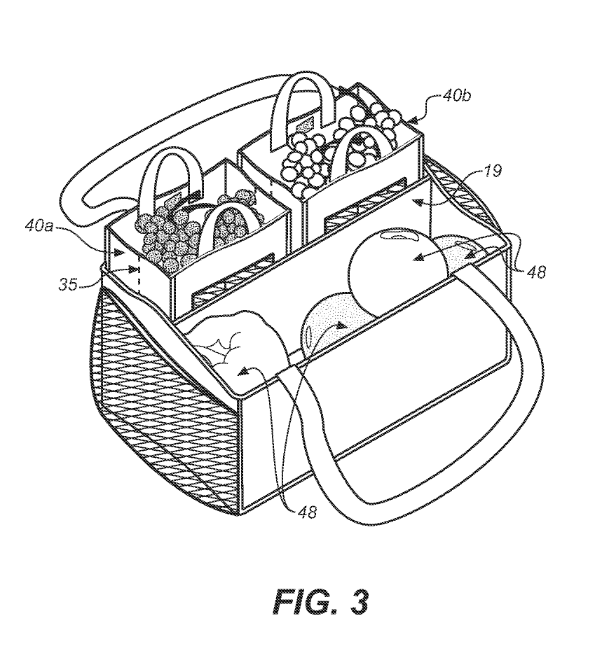

The space defined between the divider [19] and the first side panel of the caddy [16] is sufficient to contain at least two smaller bags, arranged so that when the smaller bags are filled, as in FIG. 3, the first end panel of the first smaller bag [28a] closely engages the first end panel of the caddy [14], the first side panel of the first smaller bag [24a] closely engages the divider panel [19], the second end panel of the first smaller bag [30a] closely engages the first end panel of the second smaller bag [28b], the second side panel of the first smaller bag [26a] closely engages the second side panel of the caddy [18], the first side panel of the second bag [24b] closely engages the divider panel of the caddy [19], the second end panel of the second bag [30b] closely engages the second end panel of the caddy [12], and the second side panel of the second bag [26b] closely engages the second side panel of the caddy [18].

Here “closely engages” means close enough so that the bags stay neatly contained in place within the caddy when the caddy is transported, but not so close as to make it difficult to remove the filled bags from, or replace them into the caddy.

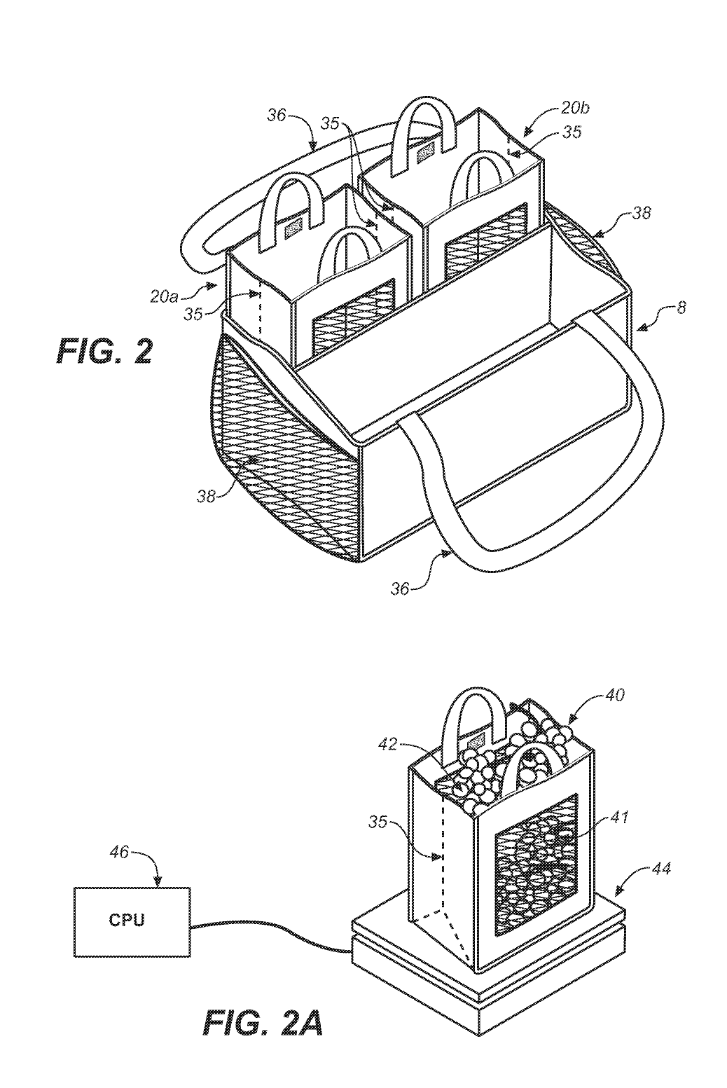

FIG. 2 shows the two smaller bags [20a, 20b] within the caddy [8]. The caddy [8] also has handles [36] suitable for carrying the caddy and its contents and mesh pockets [38] for storing empty smaller bags that are not in use. The mesh pockets [38] are also useful for storing car keys, cell phones or other small items shoppers may want to stow in a handy location while shopping.

FIG. 2A shows a filled bag [40] containing produce that is sold by weight [42]. The bag and its contents are placed on a weighing means, such as a scale [44] which is electronically linked to a specialized computing means [46] such as a grocery store “front end computer system.” “Front end systems,” as they are commonly called, are capable of receiving weight data from the scale [44] and product identification data input by the checker or other individual conducting the transaction, and calculating the sale price of the transaction. The bag [40] includes a mesh window [41] that makes it possible to identify that the contents of the bag [42] are uniform, and that the produce or other items visible through the open top of the bag is the same as the contents underneath. The window [41], which could be made of mesh or another transparent material, is useful to discourage the theft of expensive items by hiding them under a thin layer of less expensive items at the top of the bag.

FIG. 3 shows a caddy with loose produce [48] in the caddy on the front side of the divider [19], and filled bags [40a, 40b] on the back side of the divider [19]. This figure shows the caddy and smaller bags filled and ready to take to the check stand for purchase. The relatively low profile of the caddy, (as compared to conventional reusable shopping bags) and its self-standing capability, make it easy to see what items are in the bag. This is useful in minimizing contact between the loose produce [48] and the checker, because visible items sold “by each” can often be rung up for sale without the checker having to touch them at all. Those items that have to be weighed can be easily removed with minimal disturbance to the other items in the caddy. Minimizing contact between food items and the checker's hands is advantageous in promoting food safety and increasing the speed and efficiency of the transaction.

FIG. 4A shows a cross-section of the caddy of FIG. 1, revealing stiffening panels [50] within the fabric of the side panels [16, 18] and the center divider [19]. Such stiffening panels may not be necessary if the fabric used to construct the caddy is of sufficient weight and stiffness to be self-standing and to offer some degree of protection from bruising of delicate produce, over and above the minimal protection provided by plastic-film or mesh bags. Stiffening panels [50] are preferred when lighter-weight fabrics are used. The stiffening panels may be made of PET board or similar material. FIG. 4A also shows stiffening panels in the base of the caddy [52]. Like the above-described stiffening panels [50], these are an optional feature that allows the use of lighter weight fabrics. Although FIG. 4A shows the stiffening panels encased in fabric, it is also possible to affix the stiffening board to one side of the fabric with appropriate adhesive or stitching, and leave the board exposed on the other, as long as the stiffening board is made of a food-safe material, such as PET.

FIG. 4B is a cross-section of the caddy of FIG. 1, showing hinges [54] formed in the base of the bag, where the base stiffening boards [52] are split, and held together by the fabric of the base surrounding or attached to them. In examples such as FIG. 4b, where the base stiffening boards are surrounded by fabric, rather than attached to one side or the other, it is preferable to stitch through the fabric between the stiffening board down the length of the hinge [54]. This helps to define the position of the hinge and prevents the stiffening boards from moving and interfering with the hinge action. The hinges [54] allow the stiffened base to close like an accordion, which facilitates flat shipping and display of the caddy.

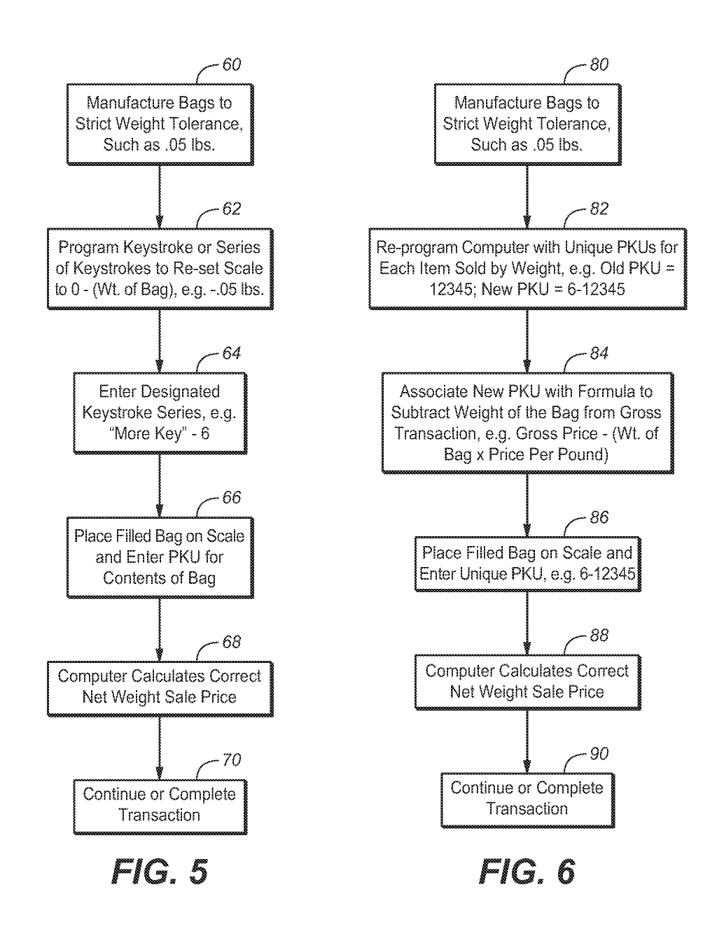

FIG. 5 is a flow chart depicting the Designated Keystroke Method. This method includes first manufacturing reusable produce bags to strict uniform weight tolerances, such as 0.05 lbs. [60]; and then entering code to transform the specialized, grocery store front end computer system to recognize a series of keystrokes as a command to tare the scale to account for the weight of the bag, e.g.: “[more key], 6”=re-set the scale at −0.05 lbs. [62]. Once the front end system is modified to recognize these keystrokes as a command to tare the scale at the appropriate weight, the checker can enter the code at the check stand [64], place the filled bag on the scale and enter the proper PLU [66]. The front end system calculates the correct net weight purchase price for the item being purchased [68] and the checker can then continue with the next item or close out the transaction [70].

FIG. 6 is a flow chart depicting the Unique PLU Method. This method includes first manufacturing reusable produce bags to strict uniform weight tolerances, such as 0.05 lbs. [80]; and then entering a unique PLU for each item sold by weight [82]. The preferred method would use new PLUs that are very similar to the old ones, such as: old PLU=12345, new PLU=612345 [82]. The next step involves programming code which transforms the front end system to recognize a unique series of keystrokes as not only a product identifier linked to a pre-coded price per unit of weight, but also as a scale tare command [84]. The tare weight command would implement a formula to subtract the weight of the bag from the transaction, e.g.: “gross price−(weight of the bag in pounds×purchase price per pound).” [84]. After the new PLUs are entered into the properly modified front end system, the checker can place the filled bag on the scale, enter the unique code [86], and the system will render a correct net-weight purchase price for the items in the bag [88]. The checker can then continue with the next item or close out the transaction [90].

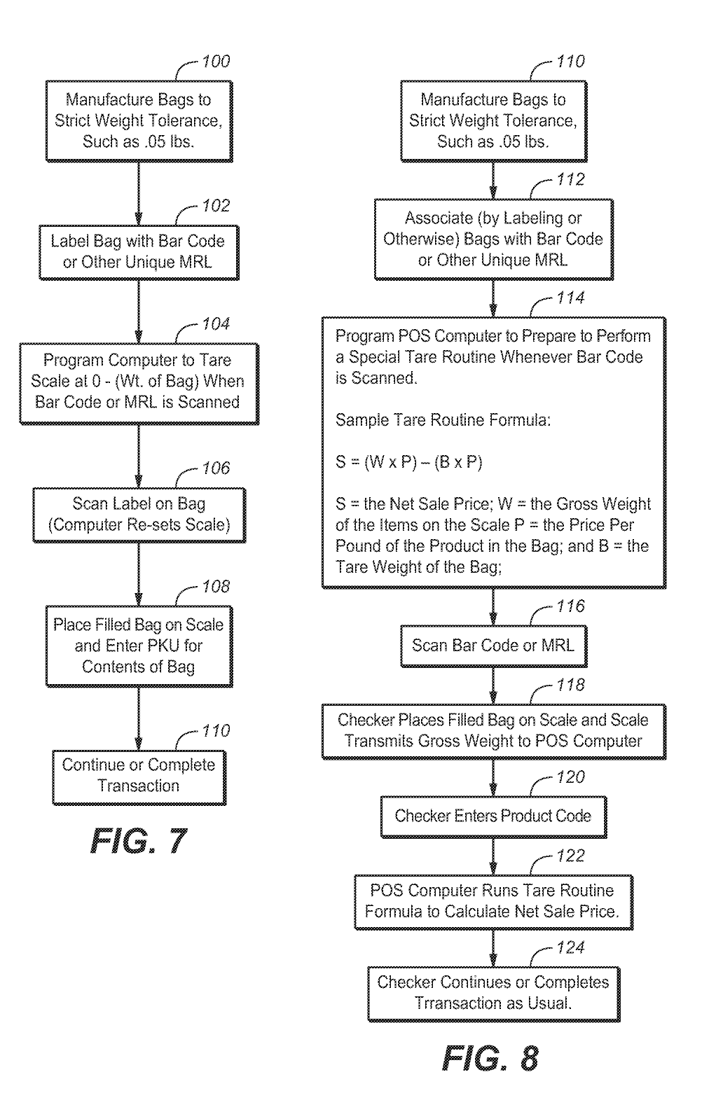

FIG. 7 is a flow chart depicting the Bar Code or MRL Method. This method includes first manufacturing reusable produce bags to strict uniform weight tolerances, such as 0.05 lbs. + or −0.1 oz [100]. The method further involves printing a bar code or other machine readable label (“MRL”) onto the bag, or otherwise associating a machine readable code with the bags. [102]. The front-end system is then modified with code that identifies the MRL with a tare weight correction command, such as “adjust scale to [0−the weight of the bag]” [104]. Once the MRL is associated with the bag and the front-end system is properly modified, the checker can simply scan the MRL on the filled bag with an appropriate MRL reader in order to tare the scale. [106]. The computer adjusts the scale or subtracts the weight of the bag from the gross sale calculation in response to the command [106]. Then, the filled bag can be placed on the scale, and the transaction can be continued in the usual way, by entering the product identification data [108]. The checker can then continue or close out the sales transaction.

FIG. 8 is a flow chart depicting an alternate tare correction formula for the of the Bar Code or MRL sales Method. This method includes first manufacturing reusable produce bags to strict uniform weight tolerances, such as 0.05 lbs. [112]. The method further involves associating a bar code or other machine readable label (“MRL”) with the bags by affixing or printing it onto the bags or by other means, such as printing it onto a card that could be scanned at the check stand. [114]. The front end system is then modified with code that identifies the MRL with a tare weight correction formula, for example:

S=(W×P)−(B×P), where

S=the net sale price; W=the gross weight of the items on the scale P=the price per pound of the product in the Bag; and B=the tare weight of the Bag [116]. Other variations on the tare correction formula will be apparent to skilled programmers, and all such variations are within the scope of the claimed method.

What is claimed is:

1) A reusable shopping system for produce and/or bulk items comprising: a plurality of bags or similar containers constructed of durable, food-safe material suitable for repeated use, including a larger, self-standing container referred to herein as a “caddy” and one or more relatively smaller containers that fit within and closely engage with the sides of the caddy.

2) The reusable shopping system disclosed in claim 1, wherein the caddy has carrying handles attached to it.

3) The reusable shopping system disclosed in claim 1, wherein the caddy is constructed of fabric reinforced with PET boards or similar material to stiffen the sides and/or bottom of the caddy.
The reusable produce shopping system disclosed in claim 3, wherein the stiffening material in the bottom is hinged, allowing it to collapse into a relatively flat position when not in use.

4) The reusable shopping system disclosed in claim 1, wherein the smaller container(s) have pleated sides and/or a pleated bottom to facilitate folding flat when not in use.

5) The reusable shopping system disclosed in claim 1, wherein the smaller container(s) include a window of mesh or other transparent or semi-transparent material, to reveal the contents of the container(s).

6) The reusable shopping system disclosed in claim 1, wherein the caddy includes pouches or pockets for storing the smaller containers when not in use.

7) A method for selling items priced by weight, including the following elements:
a) reusable containers are manufactured to strict weight tolerances, such that all such containers have the same weight to within no more than 100th of a pound;
b) the containers are labeled or otherwise associated with a machine readable label, such as a bar code or radio frequency tag;
c) the merchant's computer system (including at least a computing device, a weighing device and reading device, such as a machine readable label scanner or radio frequency tag reader) is programmed to perform a tare weight correction command when the machine readable label or radio frequency tag is scanned/read, so that when the filled container is placed on the weighing device, only the net weight of the items within the container is included in the calculation of the sale price.

8) A sales method for items sold by weight, including the following elements:
a) food-safe, reusable containers are manufactured to strict weight tolerances, such that all such containers have the same weight to within no more than 100th of a pound;
b) the containers are associated with a key or series of keystrokes on the keypad of the merchant's computer system (also including at least a computing device and a weighing device), which keystroke(s) is/are programmed to adjust the scale to 0−[weight of the bag], so that when the associated keystroke(s) is/are entered and the smaller container is placed on the weighing device, only the net weight of the items within the container is included in calculating the sale price.

9) A sales method for items sold by weight, including the following elements:
a) food-safe, reusable containers are manufactured to strict weight tolerances, such that all such containers have the same weight to within no more than 100th of a pound;
b) the merchant associates unique product code numbers to items sold by weight with the containers;
c) the unique numbers associated with the smaller containers would also be associated with a scale-tare or price correction command, so that when the unique product identification number is entered and the smaller container is placed on the weighing device, only the net weight of the items within the container is included in calculating the sale price.
